(19) United States
(12) Patent Application Publication
(10) Pub. No.: US 2003/0066937 A1
(43) Pub. Date: Apr. 10, 2003

(54) Remote control support assembly

(76) Inventor: Nathan Smith, Los Angeles, CA (US)

Correspondence Address: Liniak, Berenato, Longacre & White, Ste.240, 6550 Rock Spring Drive, Bethesda, MD, 20817, US

(21) Appl. No.: 10/108,361

(22) Filed: Mar. 29, 2002

Related U.S. Application Data
(60) Provisional application No. 60/327,750, filed on Oct. 9, 2001.

(51) Int. Cl. F16M 11/00

(52) U.S. Cl. 248/176.1

(57) ABSTRACT

A novelty support or stand that supports a standard remote control device or other hand-held electronic item, while giving the device or item features and characteristics of a pet or other animal or novel object. The support provides a useful and entertaining way to quickly and easily distinguish among different remote devices. The support stand includes identifiable features of a pet or animal or other novel object such as legs and feet upon which the remote or electronic device or item is held above table or substrate (typically a piece of household furniture) and may include other identifiable features such as a tail, ears, head, wheels, etc. The support stand therefore makes the remote or electronic device easily identifiable and/or visible in an aesthetically pleasing and entertaining manner.

This application claims benefit under 35 U.S.C. 120 based on provisional application serial No. 60/327,750 filed Oct. 9, 2001, which is hereby incorporated by reference.

### BACKGROUND OF THE INVENTION

1. Field of the Invention

The present invention relates to a support device for a hand-held item such as a remote control or other electronic device. More specifically, the present invention provides a remote control stand that simulates the appearance of an animal or other entertaining figure while supporting a hand-held remote control.

2. Description of Related Art

For many years, consumer electronic devices such as televisions, stereos, video cassette recorders, compact disc players and tape cassette players have enjoyed increased development of remote control systems to the point where virtually all such devices are available with remote control capability. The fabrication and design of such remote control units has become extremely commonplace and most include a small elongated relatively thin plastic housing having an upper face supporting a plurality of control buttons and an internally supported battery powered infrared information sending device. On the receiving consumer electronic device, an infrared responsive receiver decoder interprets the encoded infrared signals and decodes the encoded operational command producing the desired result in the unit itself.

Such remote control units initially were implemented as relatively large, often cumbersome devices. However, the continued application of advancing technology has produced control devices that having a generally standardized size and shape. Regardless, the number of control features within the remote control hand unit itself have greatly increased as the technology has been refined.

Concurrent with the development of smaller and more sophisticated control units, the general increase in the number of consumer electronic devices of the type utilizing remote control has increased dramatically. With this increased popularity and use, the remote control unit has transitioned from an optional often luxury item on a consumer electronic device to commonplace standard equipment. In line with this marketplace and product transition, consumer electronic devices have become configured and designed in anticipation of remote control operation rather than the manipulation of a plurality of front cabinet buttons, knobs and other controls. Thus, consumers no longer utilize such remote control units sparingly but rather depend upon them as their main interface with the consumer electronic device.

The need therefore exists for a useful, aesthetic and entertaining stand or locator for a remote control or other hand-held control unit.

### SUMMARY OF THE INVENTION

The present invention is a novelty item or stand that supports a standard remote control device or other hand-held electronic item, while giving the device or item features and characteristics of a pet or other animal or novel object.

An object of the present invention is to provide a useful and entertaining way to quickly and easily distinguish among different remote devices.

In accordance with the preferred embodiment of this invention, the support stand includes identifiable features of a pet or animal such as legs and feet, and perhaps with a tail, ears, head, etc. upon which the remote or electronic device or item is held above table or substrate (typically a piece of household furniture). The support stand therefore makes the remote or electronic device easily identifiable and/or visible in an aesthetically pleasing and entertaining manner.

In accordance with the preferred embodiments of the present invention, the support stand comprises a main body portion having a fastening system to retain the remote or electronic device in fixed relation to the main body portion, support legs extending from the main body portion, and optional characteristic features such as feet, shoes, boots, wheels, suction cups, etc at the end of the legs that engage and contact a substrate such as furniture.

These and other structural and functional benefits of the instant invention will become readily apparent in view of the following description and accompanying drawings.

### BRIEF DESCRIPTION OF THE DRAWINGS

FIG. 1 is an exploded perspective view of the combination remote control and stand member of the present invention using a Velcro-type or other hook-and-loop-type attachment system.

FIG. 2 is a perspective view of the remote control and stand member of FIG. 1.

FIG. 3 is an exploded perspective view of the combination remote control and stand member of the present invention using a Velcro-type attachment system whereby wheels replace the feet shown in FIG. 1.

FIG. 4 is a perspective view of the remote control and stand member of FIG. 3.

FIG. 5 is an exploded front view of the combination remote control and stand member of the present invention using a clamping attachment system to hold the remote in place.

FIG. 6 is a perspective view of the remote control and stand member of FIG. 5.

### DETAILED DESCRIPTION OF THE PREFERRED EMBODIMENT

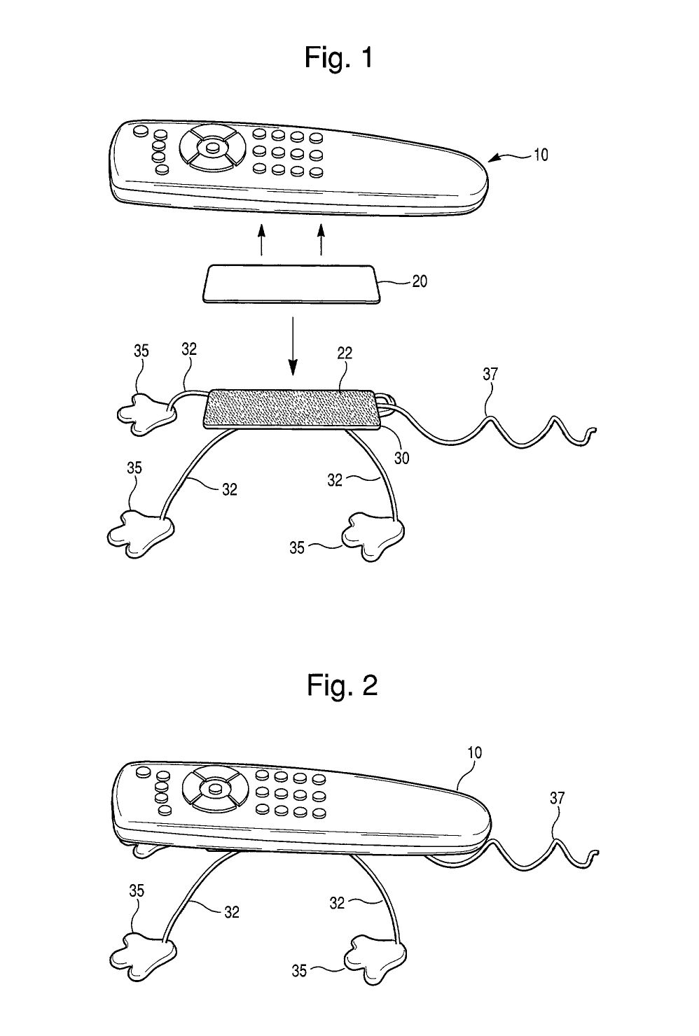

With reference to FIG. 1, the remote control device 10 may take any form and does not itself form a novel part of this invention. In accordance with this first embodiment of the present invention, the remote control device 10, however, is affixed with a Velcro-type attachment system comprising a first Velcro-type member 20 and a second Velcro-type member 22.

The remote control stand assembly of this invention comprises a main body portion 30 to which is affixed the second Velcro-type member in FIG. 1 by fasteners, adhesive and the like. A plurality of legs 32 extends away from and below the main body portion 30 to thereby raise the main body portion above a substrate such as a piece of furniture (not shown).

Substrate engaging members 35 are provided at the terminal end of the legs 32 to provide a stable support structure for the main body portion 30 and remote control device 10. The substrate engaging members 35 are shown in the form of feet in FIGS. 1 and 2; however, these engaging members may take many forms including but not limited to shoes, boots, rolling members 35a, suction cups, etc. In addition, it is envisioned by this invention that the substrate engaging members may form clips or fasteners that enable a user to mount the main body portion 30, legs 32 and remote control device 10 onto a substrate such as a piece of furniture. In this way, the stand assembly may be securely positioned next to or near the user while viewing a television, listening to music, etc.

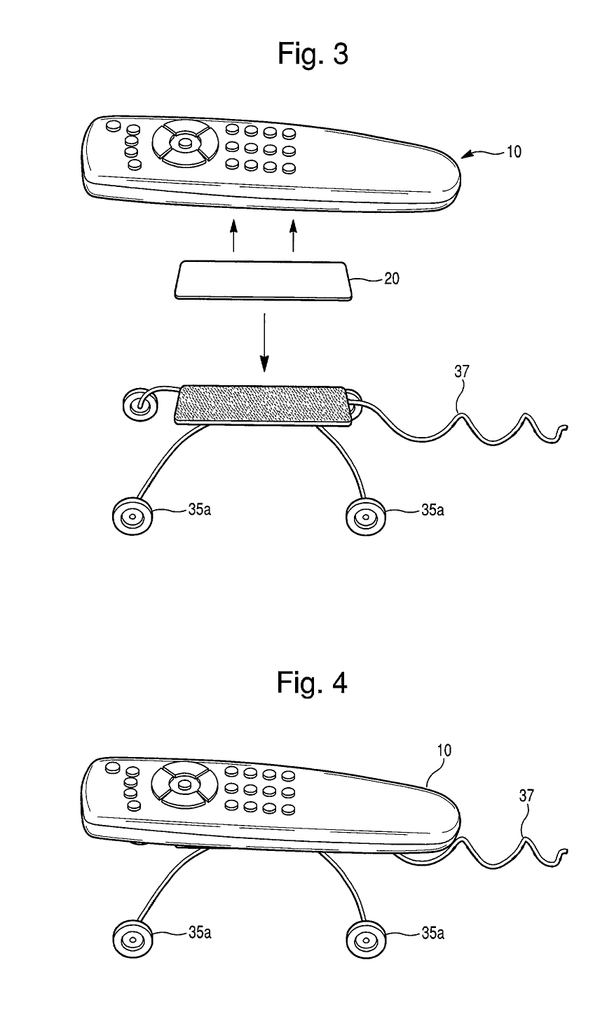

One purpose of the instant invention is to provide a stand assembly for an electronic device, e.g. a remote control, having an aesthetic and entertaining appearance. Many different embodiments and features may be employed to achieve this object and FIGS. 1-4 show, by one example, a tail 37 extending from the main body portion 30 to further emulate the appearance of a pet or other type of animal. Of course, other features such as ears, head, claws, horns, whiskers, wings, feathers, etc. may be used to create the same or similar aesthetic and entertaining appearances.

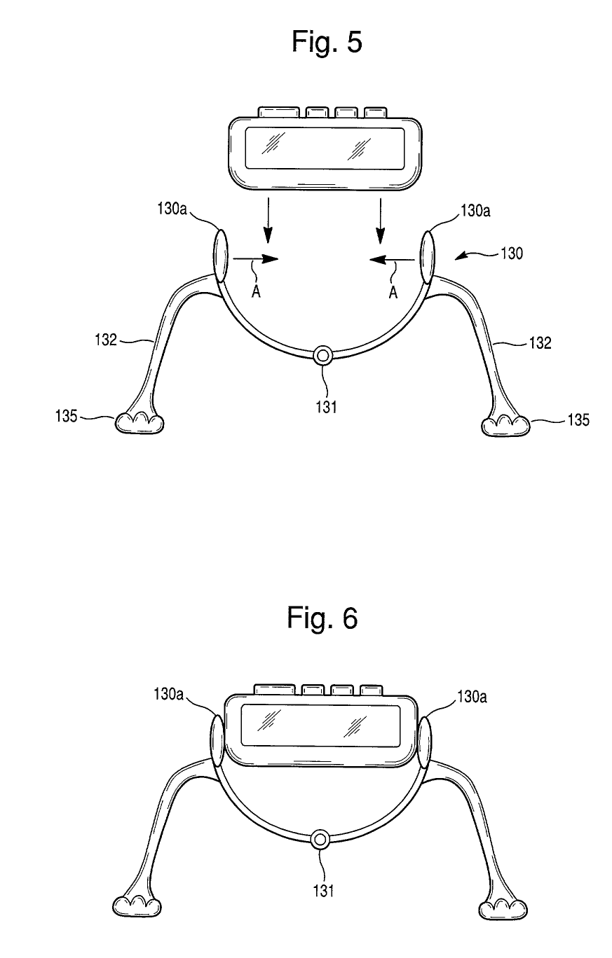

FIGS. 5 and 6 show an alternate embodiment of the present invention wherein the Velcro type attachment system shown in FIGS. 1-4 is replaced by a clamping system that uses friction to retain the remote control 10 on the main body portion 130. More specifically, the main body portion 130 may be formed as a resilient member or may be provided with a spring-loaded central member 131 that creates a clamping effect (in a direction indicated by arrows A-A) at the gripping ends 130a. In one embodiment, the main body portion 130 is formed as an elongated member with front and rear clamping sections disposed on the elongated member to surely hold the remote control 10 on the main body portion 130.

As with the previous embodiments, a plurality of legs 132 extend downwardly from the main body portion 130 to provide an elevated support for the main body portion 130. Any suitable number of legs 132 may be employed to provide a stable support structure for the stand assembly. As previously noted, substrate engagement members are provided at the terminal end of the legs 132. The substrate engaging members 135 are shown in the form of feet in FIGS. 5 and 6; however, these engaging members may take many forms including but not limited to shoes, boots, rolling members, suction cups, etc. In addition, it is envisioned by this invention that the substrate engaging members may forms clip or fasteners that enable a user to mount the main body portion 130, legs 132 and remote control device 10 onto a substrate such as a piece of furniture. In this way, the stand assembly may be securely positioned next to or near the user while viewing a television, listening to music, etc.

The support structure of the stand assembly may be made to have an internal metallic skeletal structure that is dipped or coated in a rubber or rubber-foam-like material. This coating can be colored in a variety of entertaining and aesthetically pleasing ways to enhance the style of the legs or feet or wheels etc. The structure can be formed such that the end-user can bend the legs or other parts to a certain degree to control their gesture, appearance, stance or arrangement thereby enhancing the novelty and entertainment provided by the item. For example, the stand assembly may be formed in whole or in part by a bendable wire material covered with a soft padded cloth, fabric or other soft coating or cover.

While the foregoing invention has been shown and described with reference to a number of preferred embodiments, it will be understood by those of skill in the art that various changes in form and detail may be made therein without departing from the spirit and scope of the instant invention. For example, the stand assembly may also be formed as cast or molded bodies in the form of famous or popular people or characters such as cartoon characters (e.g., Mickey Mouse, Donald Duck, etc.), actors, historical figures, etc. shown holding or otherwise supporting the remote control device.

1. A support assembly for a hand-held electronic device, said assembly comprising:
a main body portion formed to receive and retain said electronic device in an elevated standing position,
a plurality of leg members projecting from said main body portion to define said elevated standing position, and
an attachment system for attaching said electronic device to said main body portion,
wherein said main body portion and said plurality of legs simulate an appearance of a living creature.

2. The support assembly according to claim 1, wherein said main body portion is an elongated, rigid, flat member extending along a horizontal plane upon which said electronic device is adapted to stand.

3. The support assembly according to claim 1, wherein said leg members are formed of a material that is bendable and having a resiliency sufficient to hold said electronic device in a fixed position while mounted on said main body portion.

4. The support assembly according to claim 3, wherein said leg members are formed as a wire member coated with a material selected, at least in part, from the group consisting of plastic, rubber and textile fabric.

5. The support assembly according to claim 1, wherein said leg members each comprises a substrate engaging member disposed at a terminal end of said leg members opposite said main body portion.

6. The support assembly according to claim 1, wherein said substrate engaging member is formed into a shape having an appearance of an object selected from the group consisting of a foot, a shoe, a boot, a wheel, a suction cup, and an animal paw.

7. The support assembly according to claim 1, wherein said attachment system comprises at least one hook-and-loop type fastener provided on said main body portion for interaction with a corresponding fastener provided on said electronic device.

8. The support assembly according to claim 1, wherein said attachment system comprises at least one resilient clamping member for clamping said electronic device onto said main body portion.

9. The support assembly according to claim 1, further comprising a tail member simulating a tail of said living creature.

10. A combination hand-held remote control and a support assembly for said hand-held remote control, said combination comprising:
a hand-held remote control;
a support structure for said remote control comprising a mounting platform formed to receive and retain said remote control in an elevated standing position, a plurality of leg members projecting from said mounting platform to define said elevated standing position, and an attachment system for attaching said remote control to said mounting platform,
wherein said mounting platform and said plurality of legs are formed and arranged to simulate an appearance of a living creature.

11. The combination according to claim 10, wherein said mounting platform is an elongated, rigid, flat member extending along a horizontal plane upon which said remote control is mounted.

12. The combination according to claim 10, wherein said leg members are formed of a material that is bendable and having a resiliency sufficient to hold said mounting platform and said remote control in a fixed position while mounted on a substrate.

13. The combination according to claim 12, wherein said leg members are formed as a wire member coated with a material selected, at least in part, from the group consisting of plastic, rubber and textile fabric.

14. The combination according to claim 10, wherein said leg members each comprises a substrate engaging member disposed at a terminal end of said leg members opposite said mounting platform.

15. The combination according to claim 10, wherein said substrate engaging member is formed into a shape having an appearance of an object selected from the group consisting of a foot, a shoe, a boot, a wheel, a suction cup, and an animal paw.

16. The combination according to claim 10, wherein said attachment system comprises at least one hook-and-loop fastener provided one said mounting platform and at least one corresponding hook-and-loop fastener provided on said remote control.

17. The combination according to claim 10, wherein said attachment system comprises at least one resilient clamping member for clamping said remote control onto said mounting platform.

18. The combination according to claim 10, further comprising a tail member simulating a tail of said living creature.

19. The combination according to claim 10, further comprising a head member simulating a head of said living creature.
